(19) United States
(12) Patent Application Publication
(10) Pub. No.: US 2013/0226926 A1
(43) Pub. Date: Aug. 29, 2013

(54) METHOD AND APPARATUS FOR ACQUIRING EVENT INFORMATION ON DEMAND

(71) Applicant: Jerome Beaurepaire, Berlin (DE)

(72) Inventor: Jerome Beaurepaire, Berlin (DE)

(73) Assignee: Nokia Corporation, Espoo (FI)

(21) Appl. No.: 13/408,373

(22) Filed: Feb. 29, 2012

(51) Int. Cl. G06F 17/30

(52) U.S. Cl. 707/740; 707/E17.046

(57) ABSTRACT

An approach for enabling mobile device users to acquire information regarding events in their proximity on demand is described. An event determination platform processes and/or facilitates a processing of captured data (e.g., images, audio, video, etc.) that depict, at least in part, one or more events to determine one or more characteristics of the one or more events, the captured data, or a combination thereof. The event determination platform further causes, at least in part, an identification of one or more events based, at least in part, on a comparison of the one or more characteristics against one or more other characteristics associated with one or more registered events.

### BACKGROUND

Service providers and device manufacturers (e.g., wireless, cellular, etc.) are continually challenged to deliver value and convenience to consumers by, for example, providing compelling network services. One area of interest is providing users with on demand access to information about events occurring in their immediate proximity. For example, as a mobile device user travels about a given area, they may come in contact with or witness people engaged in various events or activities (e.g., a demonstration or festival). Unfortunately, the mobile device user is not always aware of pertinent details regarding the activity taking place, the type of people participating in the event, the sponsor of the event, or other information.

### SOME EXAMPLE EMBODIMENTS

Therefore, there is a need for an approach for enabling mobile device users to acquire information regarding events in their proximity on demand.

According to one embodiment, a method comprises processing and/or facilitating a processing of captured data (e.g., images, audio, video, etc.) that depict, at least in part, one or more events to determine one or more characteristics of the one or more events, the captured data, or a combination thereof. The method further comprises causing, at least in part, an identification of one or more events based, at least in part, on a comparison of the one or more characteristics against one or more other characteristics associated with one or more registered events.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of captured data that depict, at least in part, one or more events to determine one or more characteristics of the one or more events, the captured data, or a combination thereof. The apparatus is further caused to identify one or more events based, at least in part, on a comparison of the one or more characteristics against one or more other characteristics associated with one or more registered events.

According to another embodiment, a computer-readable storage medium carries one or more sequences of one or more instructions which, when executed by one or more processors, cause, at least in part, an apparatus to determine one or more characteristics of the one or more events, the captured data, or a combination thereof. The apparatus is further caused to identify one or more events based, at least in part, on a comparison of the one or more characteristics against one or more other characteristics associated with one or more registered events.

According to another embodiment, an apparatus comprises means for processing and/or facilitating a processing of captured data that depict, at least in part, one or more events to determine one or more characteristics of the one or more events, the captured data, or a combination thereof. The apparatus further comprises means for causing, at least in part, an identification of one or more events based, at least in part, on a comparison of the one or more characteristics against one or more other characteristics associated with one or more registered events.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling mobile device users to acquire information regarding events in their proximity on demand, according to one embodiment;

FIG. 2 is a diagram of the components of an event determination platform, according to one embodiment;

FIGS. 3A-3D are flowcharts of a process for enabling mobile device users to acquire information regarding events in their proximity on demand, according to various embodiments;

FIGS. 4A-4H are diagrams of user interfaces utilized in the processes of FIGS. 3A-3D, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for enabling mobile device users to acquire information regarding events in their proximity on demand are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to event registrations via a social networking service, it is contemplated that the approach described herein may be used with any offline or hosted/online applications or services for storing and sharing event information. This may include, for example, a customer relationship management database, a contact management database, a meeting planning server, a location service, or the like. In addition, although various embodiments are discussed with respect to captured data that are one or more images of an event, it is contemplated that any captured or recorded data (e.g., audio data) may be used with the embodiments described herein.

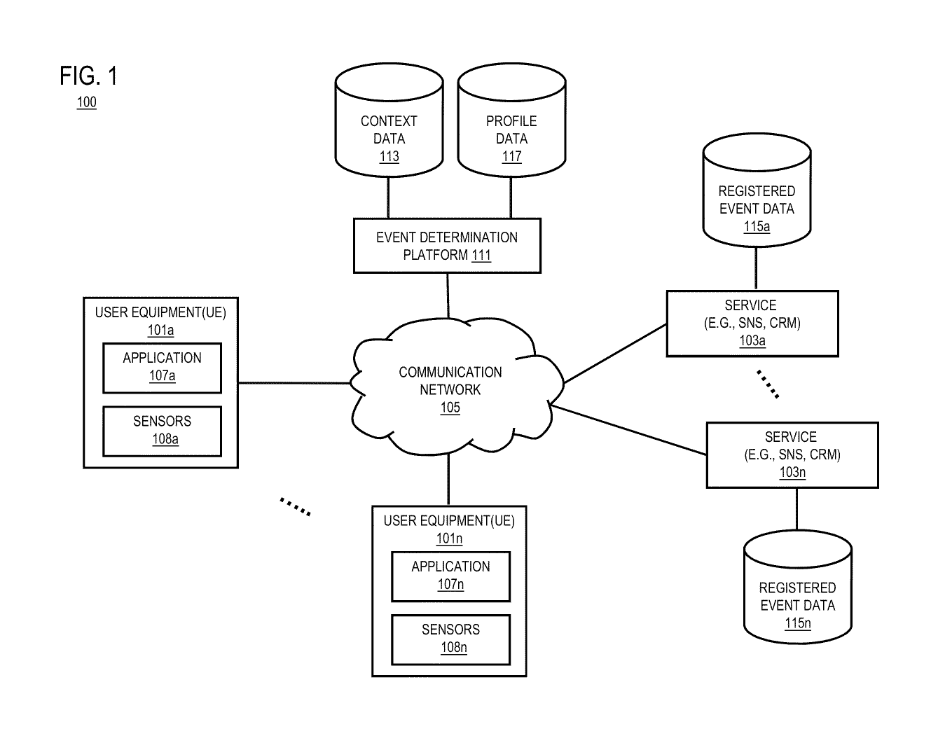

FIG. 1 is a diagram of a system capable of enabling mobile device users to acquire information regarding events in their proximity on demand. By way of example, an event determination platform 111 is configured to process captured data (e.g., an image, an audio sample or segment, a video, etc.) depicting an event occurrence. The event determination platform 111 then correlates the event depicted in the image or other captured data with a registered event featured at a social networking service or the like. Under this scenario, the correlation of the image or other captured data with the registered event also enables the user to identify one or more registered participants of the event, a sponsor of the event, etc.

As noted previously, when mobile device users travel about a given area, they may come in contact with or witness people participating in various events or activities. This is particularly likely in large, metropolitan cities, where it is common for events to be sponsored by various groups, companies, local government and other organizations. For example, while walking in the downtown area of a given city, the user may come across a gathering of people participating in a demonstration or engaged in a festival. Unfortunately, the mobile device user is not always able to access pertinent details regarding the activity taking place, the type of people participating in the event, the sponsor of the event, or other information. Moreover, the user is not able to immediately correlate the current event with the myriad of registered events published by way of a social networking site or other group sharing platform.

To address this problem, a system 100 of FIG. 1 introduces the capability to access pertinent information regarding one or more real-time event occurrences on demand. By way of example, the system 100 includes an event determination platform 111, which enables one or more of the following: (1) receives captured data (e.g., image data, audio data, video data, etc.) depicting one or more events from user equipment 101a-101n of a user on the scene; (2) performs analysis of the captured data or image to determine various characteristics of the one or more events as depicted in the image; (3) performs comparison of the determined characteristics against the characteristics of a registered event; and (4) determines if a correlation/match exists between the captured data and the one or more events based on the comparison. By correlating real-time captured data (e.g., images, sounds, videos, etc.) with one or more registered events, the user is able to identify and acquire relevant information on demand. Also, in instances where no registered event can be correlated with the captured data, the captured data may be flagged for post-processing. As such, event information can be retrieved and associated with the image when the information becomes available.

In certain embodiments, the characteristics determined as a result of analysis of a captured image or data may include one or more location characteristics, one or more temporal characteristics, environmental characteristics, or a combination thereof. Also, in certain embodiments, various perceptual characteristics may be determined pursuant to analysis of an image for distinguishing between multiple events featured in the same image frame. This includes, for example, determining a field of view, orientation or positional reference associated with the event depicted in the image or captured data. As discussed herein, the event determination platform 111 enables various processing techniques to be performed for determining the characteristics of an image or other captured data. Furthermore, the event determination platform 111 is configured to process context data, including location and time data, related to multiple users in proximity of a requesting user. As such, contextual data may be accounted for in determining the presence of and/or accuracy of an event depicted in an image or other captured data with a registered event.

For the purpose of illustration, a registered event may include any data 115 regarding events that are posted, stored, published, featured or otherwise broadcast to one or more other subscribers of a service, i.e., a social networking or location service. The registered event data 115 may include a name of the event, an event purpose, an event sponsor or host (e.g., another registered subscriber), an event time and duration, an event date and location, event registration details, etc. Other event information may also include data regarding various event affiliates or marketers, journey/route information related to the event, etc. In some embodiments, environmental characteristics (e.g., weather, ambient light levels, ambient sound levels, etc.) may be used to further describe and/or identify a particular event. For example, if it rains during the event, images or other captured data can be analyzed to determine whether they also depict the same weather condition to help identity the event.

By way of example, a subscriber to the service 103 generates an event notification, which includes one or more data fields for enabling entry of the above described details. Under this scenario, the subscriber is the host and/or sponsor of the event. Once generated, the subscriber then submits the event notification to the general public or a select group of other subscribers (e.g., friends, family and associates) belonging to the same service 103. These recipients and/or viewers of the event notification are then able to register to participate in the event, indicate their availability, provide comments regarding the event, rate the event, etc. This myriad of information is stored by the respective services 103a-103n as registered event data 115 for access by subscribers, i.e., based on one or more permission settings. In certain embodiments, the event determination platform 111 interfaces with services 103a-103n (e.g., different social networking services) such that historical and upcoming registered event data 115a-115n is accessed for analysis.

In certain embodiments, the event determination platform 111 performs a periodic or on demand check of the registered event data 115 associated with one or more users of mobile devices configured to the event determination platform 111. Hence, under this scenario, the various subscribers to the social networking service or other service 103 are also authorized to access the event determination platform 111 via their respective UE 101a-101n. The periodic or on-demand check may include, for example, receiving a direct notification from the service 103 in response to an event registration by the user. In this case, a data sharing arrangement or policy may be facilitated between the user, the provider(s) of the various service(s) 103a-103n and the provider of the event determination platform 111. Alternatively, the event determination platform 111 may periodically logon to the service 103, based on credentials provided by the user, for retrieving the registered event data 115. It is noted that the registered event data 115a-115n may be pushed and/or pulled to and/or from the respective services 103a-103n. Various other information sharing, opt-in, data transference and other schemes, mechanisms and protocols may also be implemented accordingly.

In certain embodiments, the event determination platform 111 renders a configuration interface for enabling a user of UE 101 to connect with the various services 103a-103b. The interface includes, for example, various data entry fields for specifying the services 103a-103n the user is subscribed to as well as registered event data 115 access/permission settings. The interface may also enable activation of one or more sensors 108a-108n of respective UE 101a-101n, including a location sensor, temporal sensor, gyroscope, accelerometer, or other data capture mechanism. Sensors 108a-108n enables the UE 101a-101n to determine and share current location, position or movement information related to the user as they travel within proximity of a given event. Under this scenario, all subscribers of a service 103 that are registered for an event opt to share their position information during the event for enabling other subscribers/users to view their location. The relative location of the other users/subscribers may be presented within a map. Alternatively, the presence of specific users/subscribers within physical proximity of a registered event can be presented as a list.

In certain embodiments, the registered event data 115a-115n is retrieved by the event determination platform 111 in response to a request for information regarding an image or other captured data depicting a registered event. The request includes, for example, transmission of a notification signal to the event determination platform 111 that an image depicting an event is to be processed. Furthermore, the request may include transmission of the image to be processed. By way of example, the image may be captured via an integrated camera device of UE 101 as the user is travelling about a given area. Alternatively, the image may be recalled from local memory or a network based repository via a communication network 105. It is noted that the event determination platform 111 is configured to process various images corresponding to different formats.

The image may depict, for example, one or more people participating in a demonstration at a given moment, thus representing a real-time occurrence that is newly acquired by the UE 101. Consequently, the event determination platform 111 processes the captured image in order to return pertinent information regarding the depicted event in near real-time. Alternatively, the image may be of a venue or location where an event was once held or is to be held, thus representing a past occurrence or future occurrence. Resultantly, the event determination platform 111 processes the image in order to return information for conveying a past event occurrence or future event occurrence. Hence, the event determination platform 111 is configured to analyze various characteristics of the image for enabling the rendering of event information relevant to the user; including temporal or location characteristics associated with the image.

By way of example, the image is associated with metadata for representing the current location or time of capture of the image. In addition, one or more user or auto generated tags may be packaged as metadata for association with the image. Under this scenario, when an image depicting an event is captured, the metadata and other context information related to the image, the UE 101, or user that captured or recalled the image is subsequently transmitted to the event determination platform 111 for processing. This information is stored by the event determination platform 111 as context data 113, and may include any of the data captured by one or more sensors 108a-108n of respective devices.

Processing of the image and associated context data 113 may include, for example, extracting the location, temporal, environmental information related to the image and comparing it against time, location, environmental information related to registered event data 115. In certain embodiments, the event determination platform 111 also processes the context data 113 to determine a movement trajectory associated with the registered event data 115. The movement trajectory includes a pattern, speed, course or direction of movement of one or more people participating in a registered event corresponding to the temporal or location data of the image or the UE 101. The movement trajectory may also be determined relative to the user of the UE 101 that initiates a request for event information. Such characteristics are based, at least in part, on analysis of the location and/or temporal information provided by respective sensors 108a-108n of registered subscribers within proximity of the event depicted in the image. As will be discussed more fully later on, the movement trajectory may be analyzed and subsequently translated into a recommended rendezvous location and/or rendezvous time for an event to occur relative to the current location of the user and/or the current time.

It is noted that the above described processing approaches are carried out by the event determination platform 111 without reliance upon image recognition techniques. Hence, correlation between an event depicted in the image and one or more registered events maintained as registered event data 215 is based on matching of the timing and/or temporal information with that described in the registered event data 215. For example, an image depicting one or more people participating in an art festival at a town square (e.g., designated location information) at 2 PM (temporal information) can be used for identifying other events corresponding the same location and/or time. As another example, presence and location information of the various UEs 101a-101n within proximity of the event is used to pinpoint the specific events corresponding to the determined temporal and/or location characteristics.

In certain embodiments, the event determination platform 111 is configured to interpret one or more objects (e.g., faces) featured in a captured image or data. In contrast to the processing approaches described above, the event determination platform 111 may employ various object/image, facial, audio, speech, etc. recognition techniques for enabling the identification of one or more event participants featured in an image. The identity of the one or more participants may be used in connection with the location, temporal, and/or environmental information associated with the image to determine a specific registered event data 115 correlations. For example, an image featuring a host of a registered event may be used in connection with available temporal and location information to determine the specific event name, type, function, location corresponding to that host. As will be discussed further later on, processing the image on this basis also enables multiple different events conveyed in the same image to be distinguished.

Still further, position information, field of view information and other perceptual characteristics may be used for processing images, such as to determine a relative perspective of the user during image capture. As noted above, this information may be used to distinguish between different events conveyed in the same image. For example, when the image depicts a first event and second event or object thereof, the relative angle and tilt of the UE 101 that captured the image can be analyzed to determine the focal point of the image was the second event. As another example, a field of view or perspective of the captured image may be analyzed to determine a greater portion of the image was related to the second event versus the first event; thus establishing the second event as the primary focal point. As noted previously, the sensors 108a-108n of the devices gather and provide relevant data to the event determination platform 111 for enabling the analysis.

It is noted that the image capturing sensor 108 (e.g., camera) of UE 101 may operate in connection with an image capturing or image viewing application 107. If other types of captured data (e.g., sound) are to be processed, the UE 101 can be configured with the appropriate sensors (e.g., a microphone) and/or applications. The application 107 may be a dedicated application operable by the UE 101, a browser based application, or the like. Also, the application 107 may enable the review of newly captured images as well as images captured in the past. Any means through which the user can review, acquire, or recall images depicting one or more events are within scope of the exemplary embodiments herein.

In one embodiment, once the event is identified, the event determination platform 111 can provide relevant event information to the UE 101. For example, in the case of a successful real time event identification, the user is then able to see the rest of the journey/route taken by participants presented on the UE 101. In addition to the journey or route, the event platform 111 can present, for instance, information related to registering for or participating in the identified event.

As shown in FIG. 1, the system 100 comprises user equipment (UE) 101 having connectivity to the event determination platform 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, event determination platform 111 and various services 103a-103n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

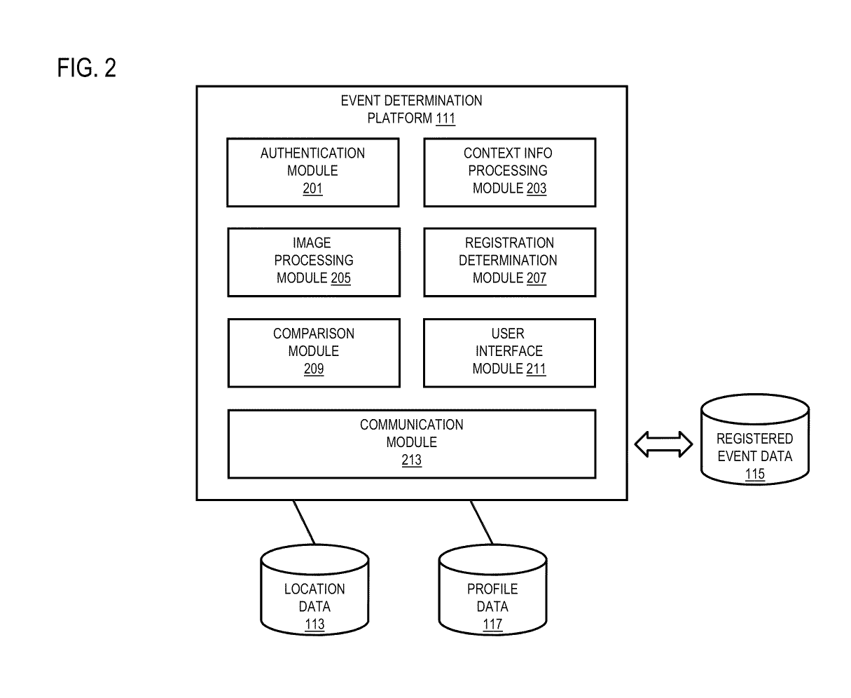

FIG. 2 is a diagram of the components of the event determination platform, according to one embodiment. By way of example, the event determination platform 111 includes one or more components for enabling mobile device users to acquire information regarding events in their proximity on demand. It is contemplated that the functions of these components may be combined in one or more components or performed by other components of equivalent functionality. In this embodiment, the event determination platform 111 includes an authentication module 201, context information processing module 203, image processing module 205 (in addition or alternatively, processing modules for other types of capture data—e.g., sound processing module—may be included for capture data of other media types), registration determination module 207, comparison module 209, user interface module 211 and communication module 213.

The aforementioned modules 201-209 of the event determination platform 111 may also access one or more databases 113, 115 and 117 for performing various executions. This includes, for example, a context database 113 for storing location, position, tilt, angle, temporal and other information pertaining to an image. Also included is a profile database 117 for maintaining profile information related to one or more users subscribed to and/or associated with the event determination platform 111. It is noted that a separate profile database (not shown) may be further associated with the various social networking services, shared media services, location services, contact management services, event coordination services and other services 103 to which the user may be subscribed. Still further, one or more registered event databases 115 may be accessed by way of communication over the network 105 with one or more services 103a-103n. The registered event databases 115 are accessible for enabling the storing and/or retrieval of information related to one or more events depicted in a captured or recalled image.

In one embodiment, an authentication module 201 authenticates users and user devices 101a-101n for interaction with the event determination platform 111. By way of example, the authentication module 201 receives a request to subscribe to the event determination platform for enabling on demand event information acquisition. The subscription process may include, for example, establishing one or more services the user is affiliated with as well as their respective access credential information. Subscription may also entail selection of an “opt-in” option, wherein users of the event determination platform 111 permit sharing of their context information (e.g., location information, position information and temporal information) with other users similarly associated with the platform 111. One or more privacy settings and/or preferences may also be established, including a restriction on the type of registered event data 115 to be retrieved in connection with a user subject to the opt-in policy. Preferences and settings information may be referenced to a specific user, user device, or combination thereof, and maintained as profile data 117. It is further noted, in certain embodiments, that the subscription process may be coordinated with a subscription process of a given service 103 accessed by a user. For example, various input data required for a user to subscribe to a social networking service or other service may be used for establishing profile data 117 for the event determination platform 111.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the platform 103 (e.g., as enabled by user interface module 215). Registration data 217 for respective subscribers, which contains pertinent user or device profile data, may be cross referenced as part of the login process. Alternatively, the login process may be performed through automated association of profile settings maintained as registration data 217 with an IP address, a carrier detection signal of a user device, mobile directory number (MDN), subscriber identity module (SIM) (e.g., of a SIM card), radio frequency identifier (RFID) tag or other identifier.

The authentication module 201 may also be configured to login to various services to which a user is subscribed to in response to an event information request. By way of example, the login is performed based on one or more credentials provided by the user during registration. It is noted that the authentication module 201 facilitates interaction with the various registered event databases 115 of various services 103 based, at least in part, on the login credentials. In certain embodiments, the event databases 115 may be related to various targeted sources as specified by the user. The targeted sources, which may include a user specified social network and/or contact, a news feed, or other resource, may be accessed by the authentication module 201 in conjunction with the comparison module; in response to a non-matching determination.

Still further, the authentication module 201 may also be configured to receive requests from UE 101a-101n to determine relevant event information based on an image depicting an event within proximity of the UE 101. By way of this approach, having authenticated the device that transmitted the image, the authentication module 201 alerts the context information processing module 203 and image processing module 205 of the request.

In one embodiment, the context information processing module 203 receives context information as gathered by the sensors 108a-108n of respective UE 101a-101n. Once received, the context information processing module 203 analyzes the context information 113 to determine the relative location, time, position or other information useful for enabling a correlation between an image and one or more registered events. In certain instances, the context information 113 is processed according to the sensor type that provided the data—i.e., if the sensor 108 is a network detection sensor, it processes and interprets the network data (e.g., internet protocol address information). Likewise, if the sensor 108 is a global positioning sensor, the module 203 interprets the gathered data as location and/or geo-spatial data. Of note, the context information processing module 203 may operate in connection with the image processing module 205 for supporting analysis of various characteristics of the image, including one or more field of view and/or perceptual factors.

In one embodiment, the image processing module 205 processes the image data received from the UE 101 of a user. This includes, for example, determining a tilt, focal point, or camera orientation of the mobile device that captured the image. Analysis of this information enables the image processing module 205 to distinguish between multiple different events depicted in the same image frame. For example, the tilt angle determined by the module 205 may be used to determine a participant depicted in the image is the focal point of the image versus a participant of another event. Based on this determination, the comparison module 209 is able to compare temporal and/or location information for the event that is the focal point with the registered event data 115 of a given service to which the user (and one or more other users in proximity of the actual event) is subscribed.

The image processing module 205 may also compute movement trajectory information related to the requesting UE 101, the UE 101 of other users determined to be within proximity of the event, the user, or the host. By way of example, the image processing module 205 analyzes the pattern, speed, course or direction of movement of one or more subscribers registered to an event corresponding to the temporal or location data related to the submitted image. Based on this analysis, the image processing module 205 generates a recommendation for indicating a predicted rendezvous time or rendezvous location. The rendezvous time and/or location corresponds to a determined point of intersection, overlap or meeting between the user that initiated the request and one or more other users registered for the same event.

In one embodiment, the image processing module 205 also employs various data recognition techniques for analyzing images. This includes, for example, object recognition and facial recognition. Any known and still developing protocols and algorithms may be employed. The image processing module 205 processes the data in order to identify one or more participants featured within an image depicting an event.

In one embodiment, the registration determination module 207 operates in connection with the comparison module 209 to determine one or more registered events that match and/or corresponds to a received image. By way of example, the registration determination module 207 retrieves the registered event data 115 from the various services to which the user is registered. Retrieval may be facilitated in conjunction with the authentication module 201, such as in accordance with various login and/or permission settings. Also, the registration determination module 207 may apply various filters for enabling the retrieval of information from the registered event database(s) 115. The filters may be applied, for example, on the basis of one or more keywords, conditions, contextual factors, etc.

The registration determination module 207 can search for registration information related to only events within proximity of the time and/or date corresponding to the context information 113. As another example, a keyword exclusion filter may cause the registration determination module 207 to prevent the retrieval and/or searching of registered event data 115 that includes the term “bachelor party” or “protest.” Still further, the module 207 may prevent the retrieval and/or search of event data 115 that is designated “private.” It is noted that the filtering capability enables the user of the event determination platform 111 to exercise privacy as their context information and/or event registration data 115 is shared. Under this approach, events of a sensitive or private nature may not be readily associated with a given user even when they are within proximity of the event (i.e., despite enabling location sharing). Furthermore, filtering enables the various different services and registered event databases 115 to which a given user may be subscribed to be more efficiently searched.

In one embodiment, the comparison module 209 determines a correlation between the one or more registered events and the one or more other characteristics of the image submitted to initiate the event information determination request. This includes, for example, comparing of time, date and location information as indicated for a registered event with the location information, temporal information and other context information 113 associated with the image. This may also include the results of any image processing performed by the image processing module 205. Resultantly, the comparison module 209 returns a matching or non-matching result based on the determined level of affinity between the registered event and the image captured and/or recalled (pursuant to the event determination request). When a match is determined to a substantial degree, a “matching” result is flagged and a matching notification message is rendered to the UE via the user interface module 211. A “non-matching” result, however, triggers rendering of a non-matching result notification message. It is noted that the non-matching result may further cause the comparison module 209 to flag the initial event determination request for post-processing; wherein the request remains active until further information regarding the event is identified.

The comparison module 209 may also present one or more possible related events to the user in association with a non-matching result notification message. Under this scenario, the comparison module 209 uses the image processing analysis results generated by the image processing module 205 and/or other registered event data 115 to generate various related event suggestions. The suggestions may be presented to the user, via the user interface module 211, ranked by relevance, distance, etc. Also, the suggestions may be presented only when at least a minimum level of affinity between the registered event and the image captured and/or recalled is determined (e.g., at least 50%).

In addition, the comparison module 209 causes the user interface module 211 to invoke event information to the display of the UE 101 that initiated the event determination request. This includes, for example, event description information, event participation information, event registration information, updated event information, or a combination thereof. Specific details contained within the information set may also include host, sponsorship, time, location and other information. It is noted that the comparison module 209, in certain embodiments, may retrieve offer and incentive information that matches the event from an incentive database (not shown). Under this scenario, the user may be presented with the various offers and incentives as an inducement to register and/or participate in the event, purchase a product provided by the sponsor of the event, etc.

Also, the comparison module 209 may enable execution of the various offers and incentives in connection with various wireless communication technologies and integration strategies. By way of example, the comparison module 209 may interpret an input triggered by reading of a coupon, offer, or other incentive as conveyed via the authentication module 201. The promotional information (e.g., a coupon) can be originated from any digital or physical source, including a banner advertisement (ad), poster, etc—any of which may be captured via the mobile device. Underlying technologies for transfer and activation of the promotional information (e.g., coupon) may include Bluetooth data transfer, near field communication (NFC) peer-to-peer transfer, or the like.

Still further, the comparison module 209 performs analysis of context data 113 of the user that initiated the event determination request, one or more users of UE 101 registered for a matching event, or a combination thereof. The effectiveness of the match is further enhanced by the determined presence of multiple different registrants within proximity of the UE 101 of the requesting user. For example, when more (e.g., a certain percentage) of the registrants associated with a given event are determined to be within physical proximity of the actual event location or the UE 101 that initiated the request, the accuracy of the correlation is confirmed and enhanced. Conversely, when fewer registrants are present, the accuracy of the correlation is lessened. As noted previously, the extent of matching and/or accuracy may correspond to a predetermined threshold (e.g., matching ≧90%)

In one embodiment the user interface module 211 enables presentment of a graphical user interface for presenting event information to the user in response to a determined correlation between an image depicting an event and a registered event. By way of example, the user interface module 211 generates the interface in response to application programming interfaces (APIs) or other function calls corresponding to the application 107 of UE 101a-101n; thus enabling the display of graphics primitives such as menus, buttons, data entry fields, etc. Also, the user interface module 211 facilitates the rendering of notification messages for conveying the status of an event determination (e.g., match or non-match). Still further, the user interface module enables the presentment of identified event information. It is noted that the user interface module 211 may be configured to operate in connection with augmented reality (AR) processing techniques, wherein various different applications, graphic elements and features may interact within the same view at the UE 101.

In one embodiment, a communication module 213 enables formation of a session over a network 105 between the event determination platform 111 and the services that maintain various registered event databases 115. By way of example, the communication module 213 executes various protocols and data sharing techniques for enabling collaborative execution between a subscriber's UE 101a-101n (e.g., mobile devices, laptops, smartphones, tablet computers, desktop computers) and the event determination platform 111 over the network 105. It is noted that the communication module 205 is also configured to support a browser session—i.e., the retrieval of content as referenced by a resource identifier during a specific period of time or usage of the browser. The browser session may support execution of a configuration interface for enabling a user to specify various settings for interacting with the event determination platform 111 and their respective services (e.g., social networking services) they are subscribed to.

The above presented modules and components of the event determination platform 111 can be implemented in hardware, firmware, software, or a combination thereof. Though depicted as a separate entity in FIG. 1, it is contemplated that the event determination platform 111 may be implemented for direct operation by respective UEs 101a-101n. As such, the event determination platform 103 may generate direct signal inputs by way of the operating system of the UE 101 for interacting with the browser application 107 and accessing content 109a-109n. In another embodiment, one or more of the modules 201-213 may be implemented for operation by respective UEs, as a platform 111, or combination thereof. Still further, the event determination platform 111 may be integrated for direct operation with a service 103, such as in the form of a widget or applet, in accordance with an information and/or subscriber sharing arrangement. The various executions presented herein contemplate any and all arrangements.

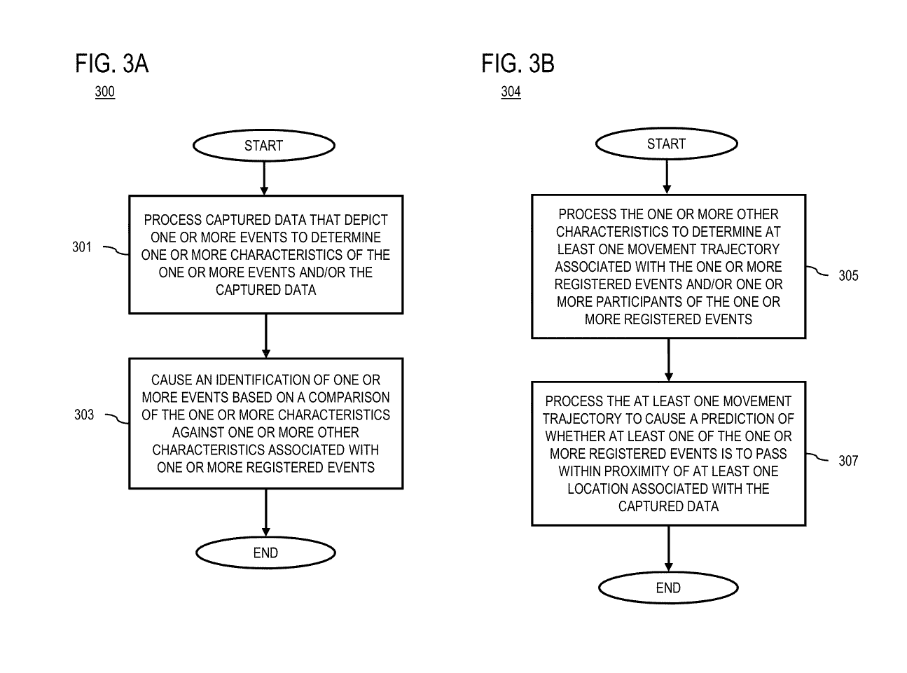

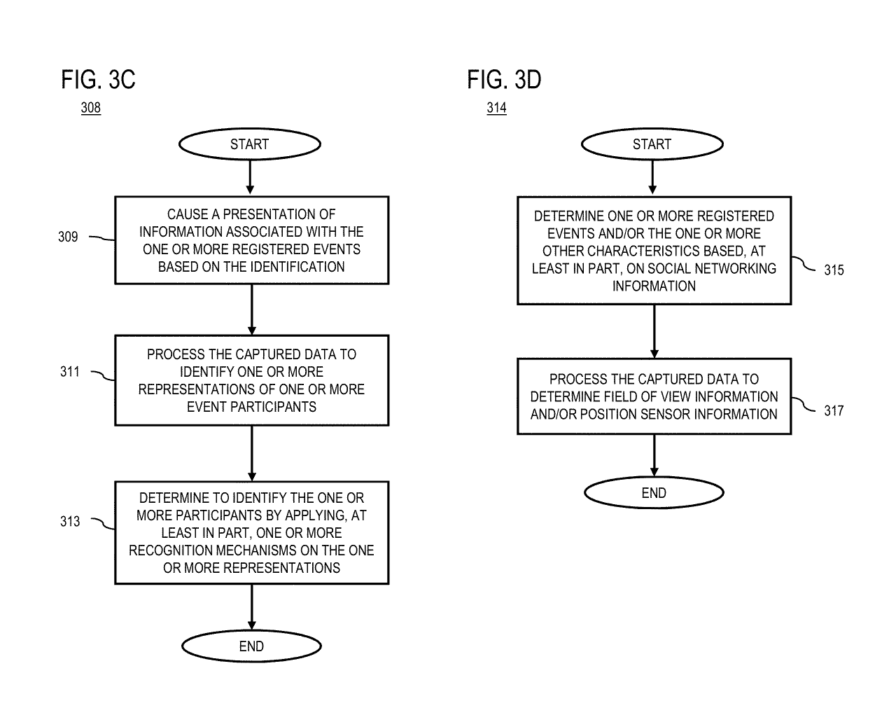

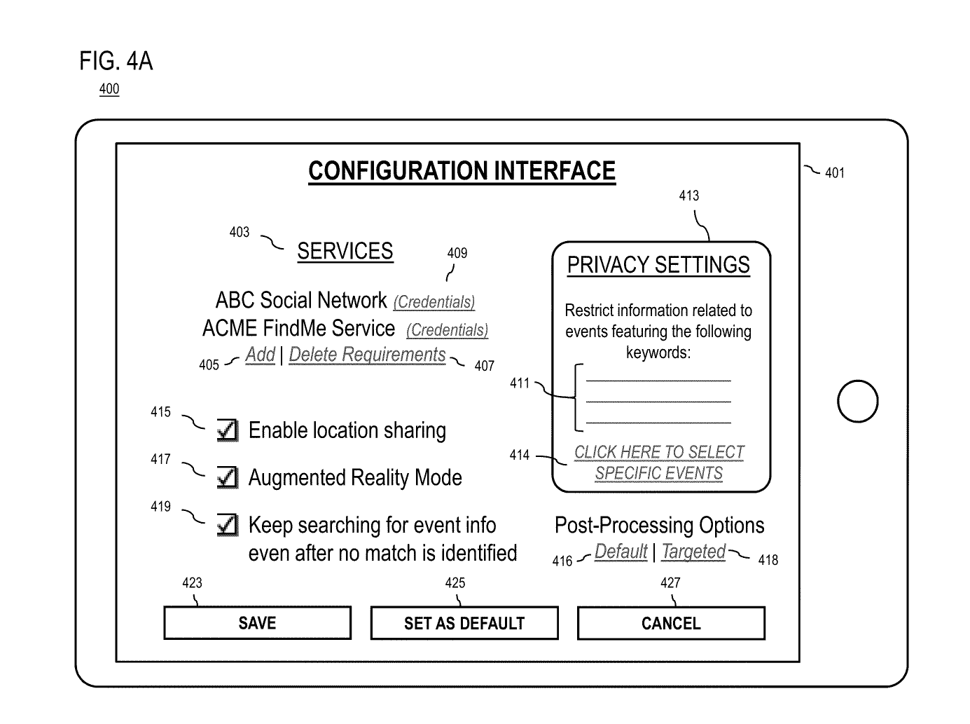

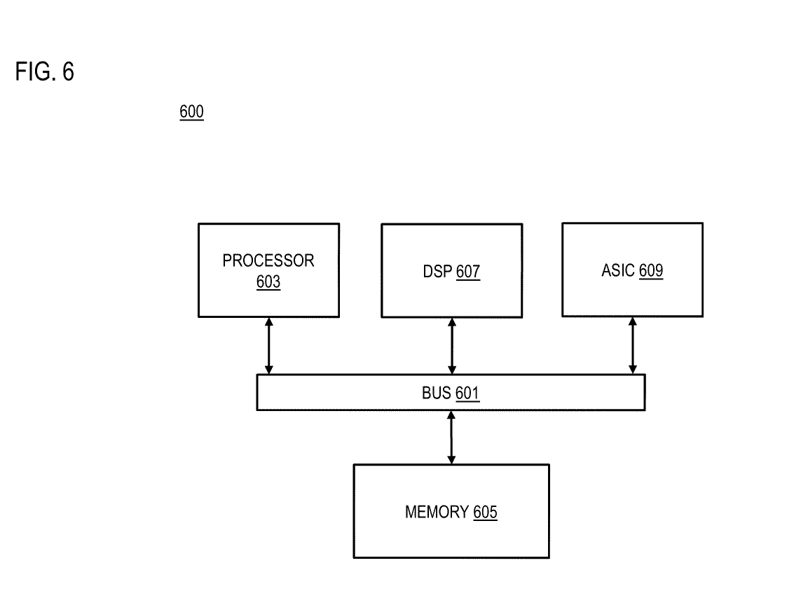

FIGS. 3A-3D are flowcharts of a process for enabling mobile device users to acquire information regarding events in their proximity on demand, according to various embodiments. In one embodiment, the event determination platform 111 performs processes 300, 304, 308 and 314 and is implemented in, for instance, a chip set including a processor and a memory as shown in FIG. 6.

In step 301 of process 300 (FIG. 3A), the event determination platform 111 processes captured data (e.g., one or more images) that depict one or more events to determine one or more characteristics of the one or more events and/or the captured data. In another step 303, the event determination platform 111 causes an identification of one or more events based on a comparison of the one or more characteristics against one or more other characteristics associated with one or more registered events. As noted previously, the one or more characteristics may include one or more location characteristics, one or more temporal characteristics, one or more environmental characteristics, or a combination thereof.

In step 305 of process 304 (FIG. 3B), the event determination platform 111 processes the one or more other characteristics to determine at least one movement trajectory associated with the one or more registered events and/or one or more participants of the one or more registered events. By way of example, the identification is based, at least in part, on determining whether the one or more location characteristics, the one or more temporal characteristics, or a combination thereof associated with the one or more events depicted in the captured data at least substantially match the at least one movement trajectory associated with the one or more registered events. As noted previously, the movement trajectory may include information for conveying a pattern, speed, course or direction of movement of one or more subscribers registered to an event corresponding to the temporal and/or location data. Per step 307, the event determination platform 111 processes the at least one movement trajectory to cause, at least in part, a prediction of whether at least one of the one or more registered events is to pass within proximity of at least one location associated with the captured data. As mentioned, the prediction may correspond to a rendezvous time, at least one rendezvous location, or a combination thereof associated with the at least one of the one or more registered events.

In step 309 of process 308 (FIG. 3C), the event determination platform 111 causes a presentation of information associated with the one or more registered events based on the identification of the one or more registered events with the captured data. The information presented includes, at least in part, event description information, event participation information, event registration information, updated event information, or a combination thereof. In step 311, the platform 111 processes the captured data to identify one or more representations of one or more event participants. As noted previously, and with respect to step 313, the event determination platform 111 identifies the one or more participants by applying one or more recognition mechanisms on the one or more representations.

In step 315 of process 314 (FIG. 3D), the event determination platform 111 determines one or more registered events and/or the one or more other characteristics based, at least in part, on social networking information. As noted previously, the social networking information may correlation to event registration data 115 as generated by way of a posting, group communication, broadcast, or published message to one or more subscribers of the social networking service.

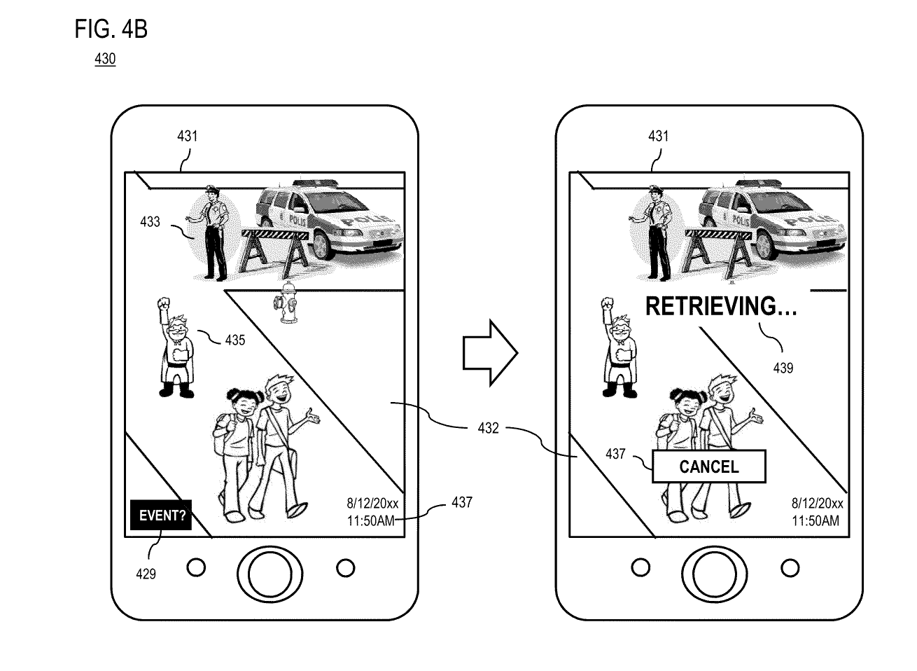

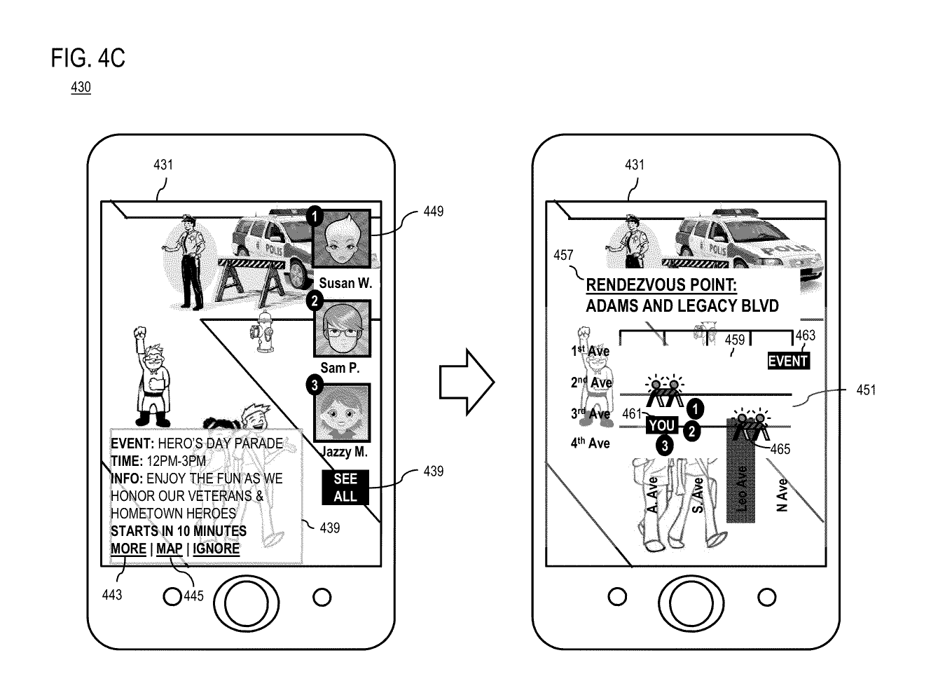

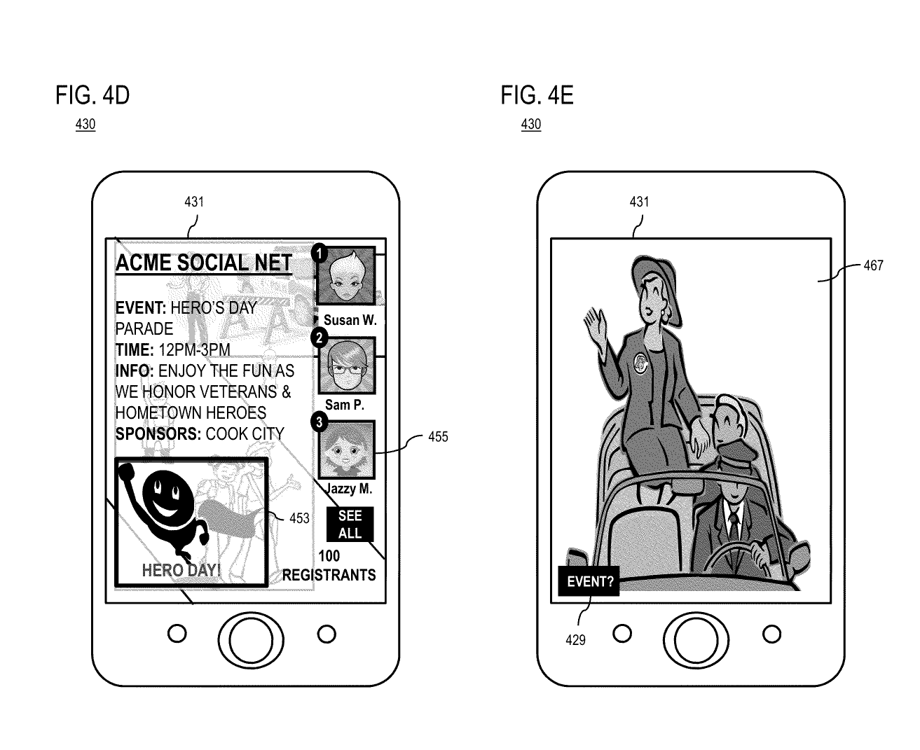

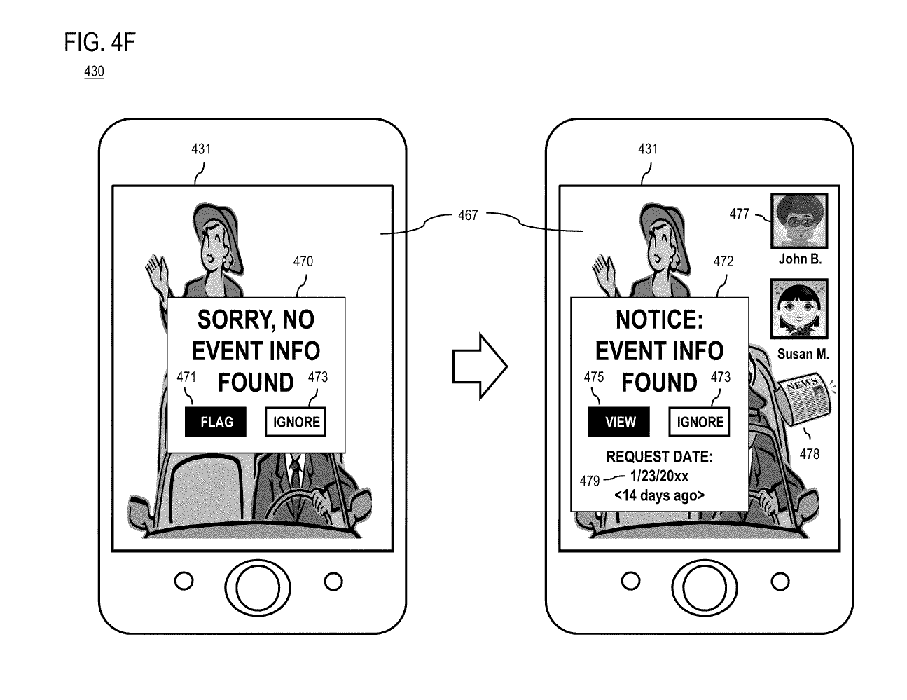

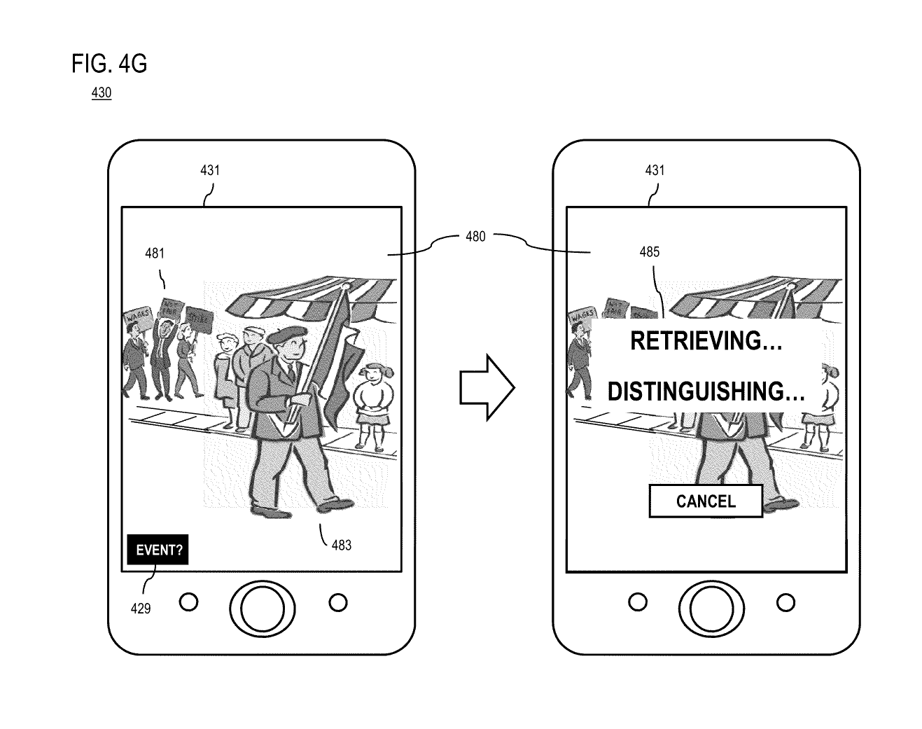

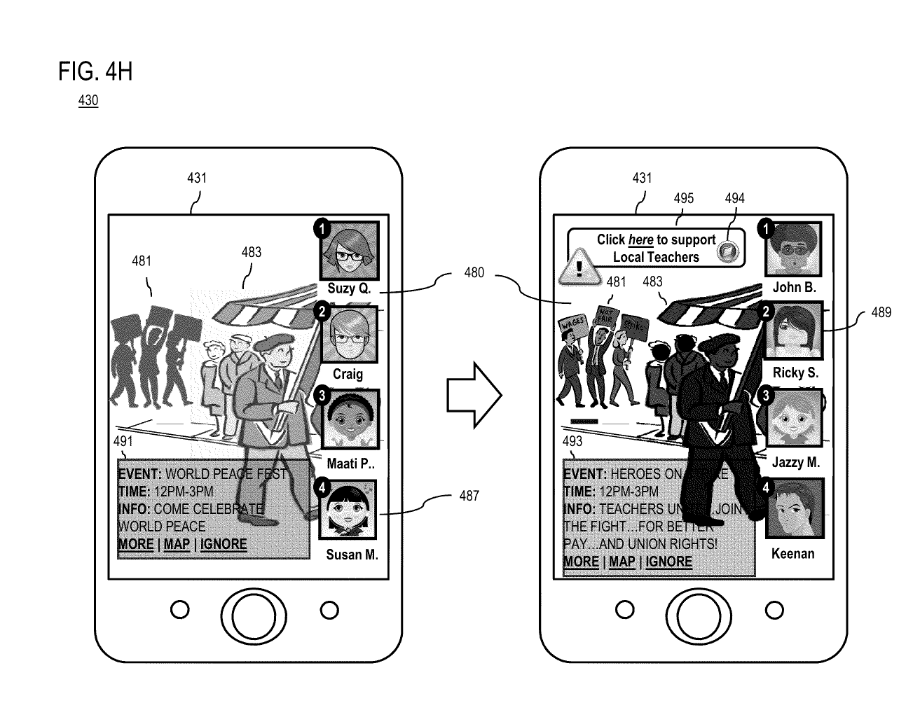

Per step 317, the event determination platform 111 processes the captured data to determine field of view information and/or position sensor information. As noted above, position information, field of view information and other perceptual characteristics may be processed to determine a relative perspective of the user during image capture. As noted above, this information may be used to distinguish between different events conveyed in the same image frame. Hence, the angle of image capture or relative percentage of one event within the frame versus another may be used to draw a distinction. More regarding this capability is presented later on with respect to FIGS. 4G-4I.

With respect to the above described processes, it is noted that the event determination platform 111 enables event correlation to be determined with or without actual image and/or facial recognition mechanisms being performed. In certain embodiments, the image recognition may be performed to support advanced image processing and analysis as required. However, analysis of the temporal information, location information and other characteristics of an image depicting an event against event registration data 115 are sufficient for rendering a matching determination. Furthermore, the effectiveness of the match is enhanced by the determined presence of multiple different registrants within proximity of the UE 101 of the requesting user. For example, when more users registered to attend a posted event are determined to be within physical proximity of the event location, the accuracy of the correlation is confirmed and enhanced.

FIGS. 4A-4H are diagrams of user interfaces utilized in the processes of FIGS. 3A-3D, according to various embodiments. For the purpose of illustration, the diagrams are described with respect to an exemplary use case of a user interacting with the event determination platform 111 via one or more of their mobile devices.

FIG. 4A depicts a configuration interface being presented to the display of a tablet device 400. The configuration interface presents various user selection options, buttons and links for enabling a user to interact with the event determination platform 111. By way of example, the user may add to or delete from a list of services 403 they are subscribed to by selecting an Add link 405 or Delete link 407 respectively. In this scenario, the services 403 include a social networking service and a location sharing service. Credentials, such as login information and group affiliation data may also be established by selecting a Credentials link 409

The user may also configure one or more privacy settings 413. The privacy settings include one or more restrictions and/or criteria to be imposed on the event determination platform 111 for accessing and/or retrieving registered event data from the various services 403. By way of example, the privacy settings include a keyword list for entry by the user via one or more data entry fields 411. The keyword list enables the user to specify one or more keywords for filtering out events. This may be used, for example, to restrict the identifying of a user with respect to an event they prefer to keep private (e.g., a private fundraiser). Alternatively, the user may select a link 414 for directly accessing a list of events they are registered for and opt to restrict these particular events. It is noted, from the perspective of a user that opts to enable location sharing (e.g., via checkbox 415), the privacy settings 413 enables some customization of the information to be shared with others who may request an event determination.

The user may also configure various post-processing options for determining the actions executed by the event determination platform 111 in response to no match being determined for a submitted image. A Default link 416 may be selected for enabling execution of a default action, including maintaining the originating event determination request in a open/unresolved status. The open/unresolved status indicates no match was determined and that the original request is to be pursued by the platform 111 until information relating to the characteristics conveyed in the image emerges. By way of the settings, the user may also indicate a period of time for continuation of an information match on an absolute or conditional basis (e.g., unlimited, 10 days, if beyond three months discontinue). Alternatively, the user may select the Targeted link 418 in order to specify specific sources to retrieve and/or receive information from. This may include, for example, members of various social networks (e.g., friends, technology group, skating group), one or more blog sites, one or more Really Simple Syndication (RSS) feeds, news and/or current event sites, media outlets, etc.

Additional checkboxes 417 and 419 are also presented for enabling the user to select/deselect Augmented Reality mode of operation and post-processing of event determinations. As mentioned previously, post-processing enables the event determination platform 111 to continue searching for event information in the instance that an initial event determination request is not fulfilled (e.g., none of the characteristics of a registered event match the characteristics of a submitted image). Under this scenario, there is no time limit associated with the return of associated event information with respect to the submitted image. This option may also result in the user being notified, such as by way of e-mail or via a notification message to the display 401, or updated event information as it becomes available.

The user can also select the SAVE action button 423 to save the configuration settings or the SET AS DEFAULT action button 425 to store the settings as a default configuration. Alternatively, the user may select the CANCEL action button 427 to cancel any entered settings and exit the configuration interface. Once the configuration settings are established, the user is able to: (1) initiate event determination requests in response to the recall and/or capture of images depicting one or more events; and (2) share context data (e.g., location information) with other users subscribed to various services (e.g., 403) and the event determination platform 111; and (3) view information regarding events and various participants thereof on demand based on detected context data, image to event registration correlation, or a combination thereof.

In FIG. 4B, a mobile device 430 of the user that performed the configuration settings of FIG. 4A is shown. In this example, as the user travels by foot around their neighborhood, they observe and subsequently capture an image 432 of a scene or event they want to learn more about. The image is presented to a display 432 of the device 430. By way of example, the image 432 is stamped with time and date information 438. The image depicts an event wherein a police officer 433 is positioned to block traffic from entering onto a major street. Also, depicted in the image 431 are various people walking along another major street that is usually subject to heavy traffic. One of the participants 435 in the event is further depicted as wearing a superhero costume. Intrigued by this event, the user decides to select the EVENT action button 429 to trigger submission of an event determination request to the event determination platform 111. As the event determination platform processes the image, context data (e.g., location and temporal information) associated with the image, and other characteristics, a status message 439 is presented. The user is also presented with a CANCEL action button 437 for canceling the event determination request and returning to image review mode.

In FIG. 4C, having determined a correlation between the characteristics of the image 432 and the characteristics of one or more registered events, event information 439 and registered participant information (e.g., participant Susan W. corresponding to avatar 449) is rendered to the display 431. By way of example, the avatars of one or more participants along with their respective names and/or social networking aliases are shown. In this scenario, only the avatars (e.g., 449) of those within the immediate social network of the user are shown. As such, this indicates to the mobile device user that there are currently people they know personally that are registered for the event and within their proximity. Each avatar is labeled (e.g., 447) with numeric values, i.e., 1-3, for enabling the relative locations of each user to be referenced in a location map 451. Alternatively, the user may select a SEE ALL action button 439 to review an expanded view/list of all registered participants that are within proximity of the device 430 or the event location.

The event information 439 includes details regarding the name of the event, a start time of the event, a description of the event, a projected time the event starts, and links 441-445 for enabling various actions of the event determination platform 111. When the user selects the More link 443, the display 431 switches to an expanded event view. In this case, the display is caused to render the social networking site from which the data was retrieved. This is depicted by way of example in FIG. 4D, which shows additional information regarding the event such as the event sponsor and a graphic 453 associated with the event. Information regarding the number of registrants for the event is also shown. While not shown, it is noted in certain embodiments that the user may also initiate a chat session with the various registrants, i.e., Jazzy W. associated with avatar 454.

When the user selects the Map link 445, the display is caused to render a map of all of the registrants that are actively sharing their event information via their user devices, corresponding to a Find All display mode. Alternatively, the user may select a Rendezvous display mode 457. The Rendezvous display mode presents a map 451, along with a recommended route or travel path 459 for the user to traverse from their present location 461 to the location of the event 463. In addition to the location of the icons of various known registrants being presented, the map 451 also presents various icons for indicating road blockades 465. Additional icons for representing various stores, landmarks and other venues may also be presented to the map 451 accordingly.

In FIG. 4E, an image 467 depicting a different event occurring at a different location and/or time is presented to the display 431 of the mobile device 430. In this example, the image is retrieved from a local storage of the device 430 and depicts a woman travelling in a vehicle with a driver and another passenger. The user decides to select the EVENT action button 429 to learn more about the event.

In FIG. 4F, the display 431 of the device 430 wherein the event determination platform 111 is unable to determine a match between the various characteristics of the image 467 and that of a registered event is depicted. By way of example, a non-matching notification message 470 is presented (e.g., “SORRY, NO EVENT INFO FOUND”). The user may select an IGNORE action button 473 to ignore the notification message 470 or a FLAG action button 471 for flagging the request and associated image for post-processing. In the case of post processing, the event determination request is maintained in an open/unresolved status by the event determination platform 111. As such, subsequent pictures, posts, webpage links, or other types of information (from various sources) whose characteristics match the image 467 may be associated accordingly.

Various post-processing actions may be further executed by the event determination module 111 to enable a closed/resolved status to be achieved. For example, the user may also submit a targeted event determination request in response to selection of the post-processing request (e.g., selection of the FLAG action button 471). The targeted event determination request is a request for information from specific sources specified by the user, including members of the social network (e.g., friends), one or more blog sites, one or more Really Simple Syndication (RSS) feeds, news and/or current event sites, etc. Under this scenario, the image 467 depicting the event, associated metadata and commentary from the user may be submitted to the source as a post, message, search index, filter criteria, or the like depending on the type of source to which the request is submitted. In response, the designated sources submit comments, links or other related information to the event determination platform 111, based on availability.

It is noted that the above described procedures may be initiated by the event determination platform 111 automatically in response to a non-matching event determination (e.g., by default). Alternatively, the user may customize the various sources and associated actions via the configuration interface of FIG. 4A.

When information regarding the event is found at a later time, a matching notification message 472 is rendered to the display 431. The matching notification message includes status details 479 for indicating the date the original event determination request was made as well as the number of days elapsed since the initial request. Also presented are IGNORE and VIEW action buttons 473 and 475 respectively. The IGNORE action button 473 in this case allows the user to ignore the matching notification message 472. This flags the notification to be presented at a later time or stored for later viewing by the user. TheVIEW action button 475 enables the user to review any retrieved/compiled event information, which may include various links, commentary from contacts within various social networks, news articles, pictures, related advertisements, press releases, etc. When the user selects the VIEW action button 475, one or more avatars and associated name information for various subscribers of the service that contributed to the event information (e.g., avatar 477 associated with John B.) are also shown. In the case of a targeted resource such as an online news reporting source, an icon 478 representing the corporate logo or online identify of the provider is shown.

In FIG. 4G, the user captures an image 480 that depicts participants of different events within the same image. By way of example, some of the participants featured in the image are associated with a festival, such as a person 483 walking along a street with a flag. Also depicted in the image 483 are various protesters 481 participating in a teacher's strike. When the user selects the EVENT action button 429, a status message 485 is presented to the display 431 for informing the user that the event determination request has been submitted and is being processed. The status message 485 also presents information for the image pertains to multiple different events. As noted above, this determination may be based on the determined presence of one or more registered subscribers in proximity to the device 430 along with the availability of event information via one or more sources.

In FIG. 4H, the event determination platform 111 renders event information 491 to the display 431 of the mobile device 430 that is related to the one or more participants 483 of the festival. In this case, the festival is determined to be the primary event depiction within the image frame 480. This is based, for example, on processing of the image 480 to determine a relative field of view or position of the user with respect to the captured image 480. As another example, the captured image may be analyzed to determine a greater portion of the image 480 is related to the one or more participants 483 of the festival than the participants 481 of the protest.

Resultantly, the event determination platform 111 renders the protesters 481 to the display in a masked/silhouette mode while the participants 483 related to the other event are presented normally. In addition to the event information 491 related to the festival, the avatars of one or more participants along with their respective names and/or social networking aliases are shown (e.g., participant Susan M. corresponding to avatar 487.

The user may also toggle to the event information 493 related to the protest by selecting (e.g., tapping the touch screen of the device 430) the masked/silhouette image of the protesters 481. Upon selection, the image of the participants 483 of the festival are caused to be rendered in a masked/silhouette mode while the participants 481 related to the other event are presented normally. In addition to the event information 493 related to the protest, the avatars of one or more participants along with their respective names and/or social networking aliases are shown (e.g., participant Ricky S. corresponding to avatar 489).

Also presented is an object link 495 for enabling the user to donate to a cause related to the protest. The link may be presented to the display 431, in response to the location of the mobile device 430 being in proximity to the determined event (e.g., event 483). Alternatively, the object link 495 is invoked based on activation of an NFC tag by the mobile device 430 or receipt of event information from sponsors of the event via Bluetooth communication. In the case of NFC tags, these tags may be placed visibly on various objects related to the event (e.g., posters, placards), which is tapped and/or imaged by the device 430. It is noted that the tags may also contain a link to the event, related files, and other information relevant to the event. In the case of Bluetooth, the user can opt save the information for review later by selecting a file button 494. By way of this approach, users not comfortable with the local language can file the information (e.g., in this case the donation request) about the event, have it translated into their native language, etc.

Upon selection of the object link 495, the user may be directed to a website of the organization that sponsored the event, an affiliate, a donation processing form, etc. It is noted that the execution performed upon selection of the object link 495 will vary depending on the information conveyed to the event determination platform 111 via the NFC tag, Bluetooth communication, etc.

It is noted that the event determination platform 111 may be configured to use various types of data as search input for enabling fulfillment of an event determination request. By way of example, the user may retrieve journey route and planned end point information upon arriving at the end point of a public demonstration or other past event (e.g., all participants are gone). Also, as some sporting events and other public venues occur on a regular basis (e.g., every week, month), an image depicting the location of such an event may be used by the event determination platform 111 to enable retrieval of season schedule information, ticket purchase information, final score information, video clips of the last game corresponding to the location, etc.

The processes described herein for enabling mobile device users to acquire information regarding events in their proximity on demand may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

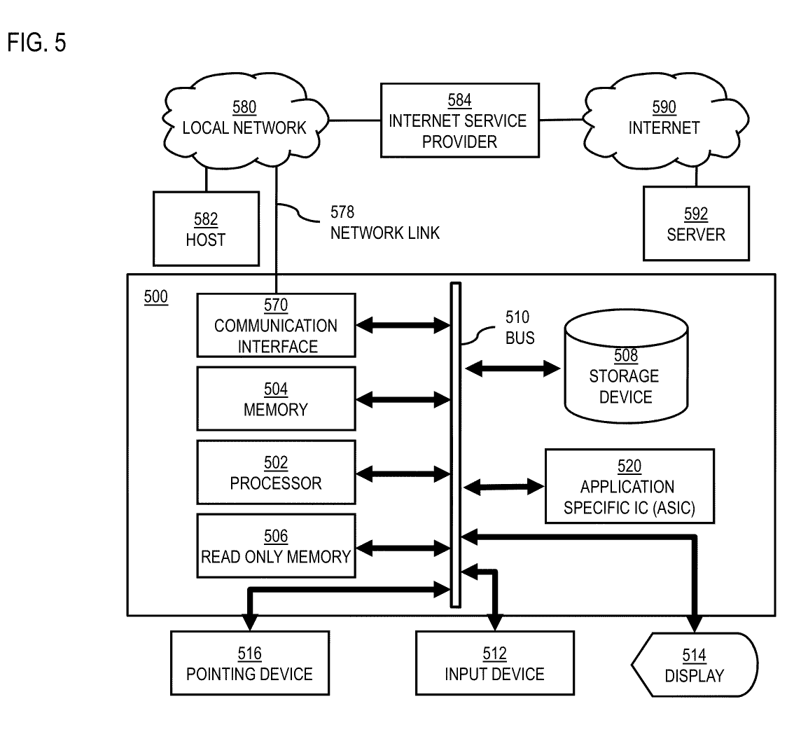

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to enable mobile device users to acquire information regarding events in their proximity on demand as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of enabling mobile device users to acquire information regarding events in their proximity on demand.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to enable mobile device users to acquire information regarding events in their proximity on demand. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for enabling mobile device users to acquire information regarding events in their proximity on demand. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for enabling mobile device users to acquire information regarding events in their proximity on demand, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for enabling mobile device users to acquire information regarding events in their proximity on demand to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to enable mobile device users to acquire information regarding events in their proximity on demand as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of enabling mobile device users to acquire information regarding events in their proximity on demand.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable mobile device users to acquire information regarding events in their proximity on demand. The memory 605 also stores the data associated with or generated by the execution of the inventive steps.

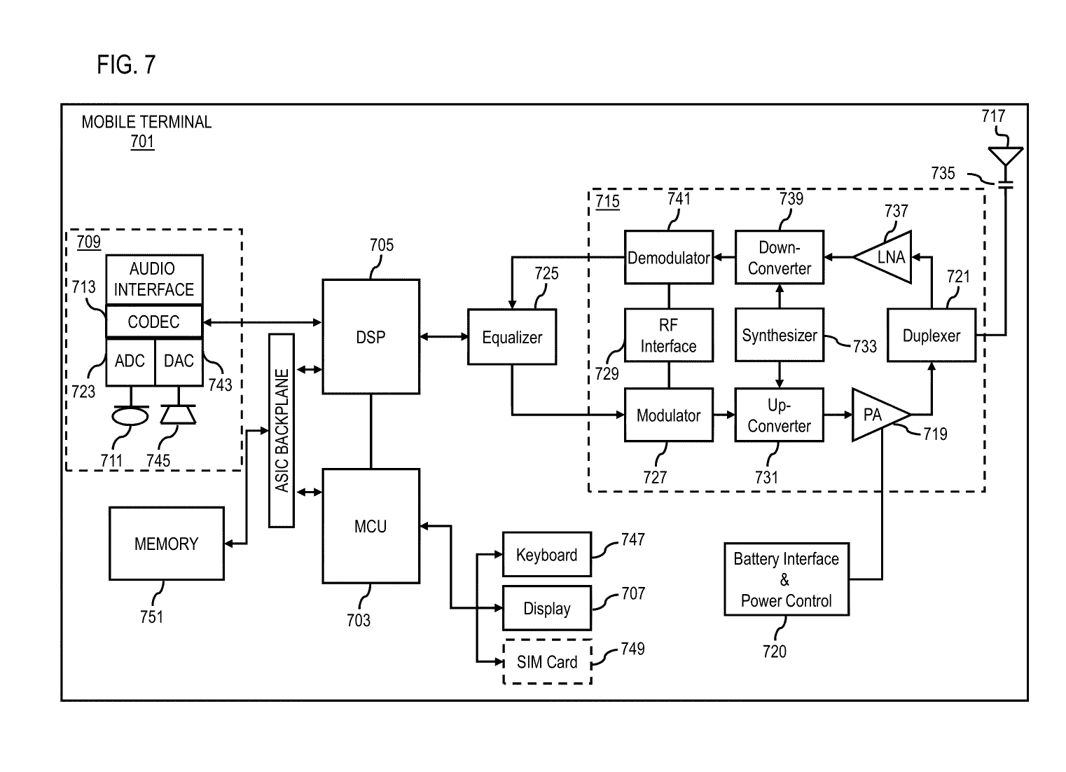

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of enabling mobile device users to acquire information regarding events in their proximity on demand. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of enabling mobile device users to acquire information regarding events in their proximity on demand. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to enable mobile device users to acquire information regarding events in their proximity on demand. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of captured data that depict, at least in part, one or more events to determine one or more characteristics of the one or more events, the captured data, or a combination thereof; and
an identification of one or more events based, at least in part, on a comparison of the one or more characteristics against one or more other characteristics associated with one or more registered events,
wherein the captured data include, at least in part, one or more previously captured images, one or more substantially real time images, or a combination thereof.

2. A method of claim 1, wherein the one or more characteristics, the one or more other characteristics, or a combination thereof include, at least in part, one or more location characteristics, one or more temporal characteristics, or a combination thereof.

3. A method of claim 2, wherein the (1) data and/or (2) information and/or (3) at least one signal are further based, at least in part, on the following:
a processing of the one or more other characteristics to determine at least one movement trajectory associated with the one or more registered events, one or more participants of the one or more registered events, or a combination thereof,
wherein the identification is based, at least in part, on determining whether the one or more location characteristics, the one or more temporal characteristics, or a combination thereof associated with the one or more events depicted in the captured data at least substantially match the at least one movement trajectory associated with the one or more registered events.

4. A method of claim 3, wherein the (1) data and/or (2) information and/or (3) at least one signal are further based, at least in part, on the following:
a processing of the at least one movement trajectory to cause, at least in part, a prediction of whether at least one of the one or more registered events is to pass within proximity of at least one location associated with the captured data.

5. A method of claim 4, wherein the prediction includes, at least in part, at least one rendezvous time, at least one rendezvous location, or a combination thereof associated with the at least one of the one or more registered events.

6. A method of claim 1, wherein the (1) data and/or (2) information and/or (3) at least one signal are further based, at least in part, on the following:
a presentation of information associated with the one or more registered events based, at least in part, on the identification,
wherein the information includes, at least in part, event description information, event participation information, event registration information, updated event information, or a combination thereof.

7. A method of claim 1, wherein the (1) data and/or (2) information and/or (3) at least one signal are further based, at least in part, on the following:
a processing of the captured data to identify one or more representations of one or more event participants; and
at least one determination to identify the one or more participants by applying, at least in part, one or more recognition mechanisms on the one or more representations.

8. A method of claim 1, wherein the (1) data and/or (2) information and/or (3) at least one signal are further based, at least in part, on the following:
at least one determination of the one or more registered events, the one or more other characteristics, or a combination thereof based, at least in part, on social networking information.

9. A method of claim 1, wherein the (1) data and/or (2) information and/or (3) at least one signal are further based, at least in part, on the following:
a processing of the captured data to determine field of view information, position sensor information, or a combination thereof,
wherein the identification is further based, at least in part, on the field of view information, the position sensor information, or a combination thereof.

10. A method of claim 1, wherein the captured data further include, at least in part, one or more previously captured audio segments, one or more substantially real time audio segments, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of captured data that depict, at least in part, one or more events to determine one or more characteristics of the one or more events, the captured data, or a combination thereof; and
cause, at least in part, an identification of one or more events based, at least in part, on a comparison of the one or more characteristics against one or more other characteristics associated with one or more registered events,
wherein the captured data include, at least in part, one or more previously captured images, one or more substantially real time images, or a combination thereof.

12. An apparatus of claim 11, wherein the one or more characteristics, the one or more other characteristics, or a combination thereof include, at least in part, one or more location characteristics, one or more temporal characteristics, or a combination thereof.

13. An apparatus of claim 12, wherein the apparatus is further caused to:
process and/or facilitate a processing of the one or more other characteristics to determine at least one movement trajectory associated with the one or more registered events, one or more participants of the one or more registered events, or a combination thereof,
wherein the identification is based, at least in part, on determining whether the one or more location characteristics, the one or more temporal characteristics, or a combination thereof associated with the one or more events depicted in the captured data at least substantially match the at least one movement trajectory associated with the one or more registered events.

14. An apparatus of claim 13, wherein the apparatus is further caused to:
process and/or facilitate a processing of the at least one movement trajectory to cause, at least in part, a prediction of whether at least one of the one or more registered events is to pass within proximity of at least one location associated with the captured data.

15. An apparatus of claim 14, wherein the prediction includes, at least in part, at least one rendezvous time, at least one rendezvous location, or a combination thereof associated with the at least one of the one or more registered events.

16. An apparatus of claim 11, wherein the apparatus is further caused to:
cause, at least in part, a presentation of information associated with the one or more registered events based, at least in part, on the identification,
wherein the information includes, at least in part, event description information, event participation information, event registration information, updated event information, or a combination thereof.

17. An apparatus of claim 11, wherein the apparatus is further caused to:
process and/or facilitate a processing of the captured data to identify one or more representations of one or more event participants; and
determine to identify the one or more participants by applying, at least in part, one or more recognition mechanisms on the one or more representations.

18. An apparatus of claim 11, wherein the apparatus is further caused to:
determine the one or more registered events, the one or more other characteristics, or a combination thereof based, at least in part, on social networking information.

19. An apparatus of claim 11, wherein the apparatus is further caused to:
process and/or facilitate a processing of the captured data to determine field of view information, position sensor information, or a combination thereof,
wherein the identification is further based, at least in part, on the field of view information, the position sensor information, or a combination thereof.

20. An apparatus of claim 11, wherein the captured data further include, at least in part, one or more previously captured audio segments, one or more substantially real time audio segments, or a combination thereof.

21-48. (canceled)
